(19) United States
(12) Patent Application Publication
(10) Pub. No.: US 2016/0034713 A1
(43) Pub. Date: Feb. 4, 2016

(54) Decentralized Systems and Methods to Securely Aggregate Unstructured Personal Data on User Controlled Devices

(71) Applicant: Apothesource, Inc., Easley, SC (US)

(72) Inventor: Michael A. Ramirez, Easley, SC (US)

(73) Assignee: Apothesource, Inc.

(21) Appl. No.: 14/466,133

(22) Filed: Aug. 22, 2014

Related U.S. Application Data
(60) Provisional application No. 62/032,707, filed on Aug. 4, 2014.

(51) Int. Cl. G06F 21/62; H04L 29/06

(52) U.S. Cl. CPC G06F 21/6254; H04L 63/0428

(57) ABSTRACT

A privacy-preserving decentralized computer-implemented system and method for securely aggregating an individual's personal data by extracting, redacting, normalizing, and linking data from a plurality of the individual's personal accounts and services.

### CROSS-REFERENCE TO RELATED APPLICATIONS

This application claims priority from U.S. Provisional Patent Application No. 62/032,707, filed Aug. 4, 2014, herein incorporated by reference in its entirety.

### BACKGROUND OF THE INVENTION

The proliferation of web-based accounts containing personal data continues to increase. Personal data is defined herein as data created by or otherwise belonging to an individual user. Often such personal data also contains Personally Identifiable Information (PII), defined herein as any specific data element that enables the identification of the individual to whom the information applies. Examples of such identifiers include users' given or family names, home address, Social Security Numbers (SSN), account/user identification numbers, or date of birth.

For certain types of personal accounts such as email & messaging, highly structured standards like IMAP and XMPP were defined thus making very powerful personal tools possible. Now, no matter how many email accounts you use, message clients often offer an integrated view (e.g. ‘combined inbox’) and other organizational tools that significantly improve the ability to quickly and efficiently manage this PII information.

Unfortunately, other personal information domains and account types have largely languished. Personal financial data, for example, has limited defacto standards as a result of widespread use of otherwise proprietary specifications such as the Quicken Interchange Format (QIF). While sufficient for some very limited use cases, the inconsistencies of vendor-specific implementations and incompleteness of the user's data severely limits the general utility of the information. In other domains such as healthcare, comprehensive standards for personal records do exist including Continuity of Care Document/Record (CCD/CCR), though support from Electronic Health/Medical Record (EHR/EMR) vendors is nearly non-existent. The U.S. Government has begun efforts in earnest to promote personal health data accessibility through their ‘Blue Button’ efforts, but widespread support appears to be years away in even the best case scenario.

In healthcare, for example, doctors (providers) and institutions are just starting to allow patients to view and download subsets of their healthcare information highly restrictive ‘patient portals’ where the data provided are often incomplete, poorly structured, and isolated/unlinked with other relevant healthcare information. This results in patients having to manually collect their data from each provider's site and attempt to manually collect and integrate the information on their own, a highly complicated and error-prone process.

Many software-based solutions have been developed and marketed to help patients manage their health information, ranging from self-managed Personal Health Record (PHR) applications to simpler medication “reminder” software. Such solutions are often undesirable due to the continuous burden placed on the patient to routinely collect, transcribe, and logically integrate their data into a non-standard format defined by the PHR. This requirement leads to user confusion, fatigue, omissions, and other errors that render the utility and accuracy of such applications and systems to be very limited. This has the unfortunate result of reducing overall patient engagement and medication adherence.

An alternative solution that reduces this patient-driven data entry burden are “tethered” PHRs and patient portals. Healthcare providers often offer these tools to patients as an extension of their larger institutional Electronic Medical/Health Record (EMR/EHR) or Pharmacy Information Management System (PIMS). Since such solutions are updated by virtue of the providers' actions, they require little input from patients directly. These tethered solutions lack the flexibility of self-managed PHRs, however, as they are generally limited to the information and services available in the parent institutional system.

More recent efforts aim to improve patient's access to their electronic health data via standardized data models such as Continuity of Care Record or Documents (CCR/CCD) and through standardized interfaces similar to those defined by the US Government's Blue Button initiative. Such interfaces are becoming more popular and indeed represent a highly desirable end-state for healthcare information standardization, though the slow pace of adoption and significant fragmentation of these standards currently yields inconsistent and incomplete data for patients in most cases.

Additionally, a recently disclosed method [Publication #WO2013165970] describes a healthcare-specific strategy for addressing these gaps in structured patient data by extracting unstructured data from tethered patient portals the patient's existing healthcare portals and tethered PHRs. The claimed invention describes a method that closely approximates existing processes used by financial data aggregation services like Mint.com, PageOnce, and Yodlee. Such solutions follow a common aggregation heuristic, requiring each solution provider to furnish a centralized server that (a) it collects a user's private authentication credentials (e.g. a username & password) for each website where the user has relevant personal data, (b) using the credentials to remotely access and authenticate to the website in order to extract the denormalized personal data, and (c) transferring the personal data information back to the centralized server to be integrated into the user's record. Centralized servers are defined herein as any general computing platform used in a multi-tenant fashion, storing processing and storing data for distinct users concurrently. While this approach of aggregating personal data using centralized servers has proven effective, it severely impairs the privacy for their users since the owner of the centralized server enjoys access to an incredible amount of personal information about each individual user. Additionally, users must permit full control of their accounts to these centralized servers, granting an otherwise unaffiliated 3^{rd} party unfettered access to review and modify highly sensitive personal accounts and information. Finally, even if an honest centralized system owner is assumed, this approach still creates the significant risk of such systems being infiltrated by unauthorized third parties (e.g. hackers) or misappropriation/misuse by employees and contractors (i.e. insiders) of the solution provider. To truly ensure privacy of users, solutions should be designed to keep sensitive personal data, including PII, as close to the user as possible and out of such centralized systems. The current invention provides this privacy solution that has not been previously taught or practiced.

### BRIEF SUMMARY OF THE INVENTION

One aspect of the invention provides a decentralized, or distributed, privacy-preserving method of aggregating personal information operating on an internet-connected computing device and on behalf of an individual or subgroup of individual users, hereafter identified as a ‘User-Controlled Computing Device’ (UCCD). Various embodiments of a UCCD may be realized, including an internet-connected smartphone, desktop computer, tablet device, or logical software system such as a Virtual Machine. The method defines a general use technique to autonomously access and authenticate into a remote personal data source/site, extract and optionally redact relevant portions of the site representing the user's specific personal data, transform the data into normalized but de-identified data structures, linking the resultant entities to existing concepts and registries, and integrating these entities back into the user's personal record.

Another aspect of the invention is a computer-implemented privacy-preserving method and system for aggregating unstructured personal data by accessing at least one external account to form extracted personal data using a user-controlled computing device (UCCD), redacting relevant portions of the extracted personal data representing personal identifiable information (PII) using the UCCD and thereby forming de-identified personal data, transforming the de-identified personal data into normalized structured data by at least one UCCD and/or at least one centralized augmentation system, and storing the normalized structured data in the user's current profile on the UCCD.

Another aspect of the invention adds an additional party to the system and method by transmitting the de-identified personal data to at least one centralized augmentation system to perform the transforming step remote from the UCCD, receiving the normalized structured data from the at least one augmentation system into the user's current profile prior to storing, and integrating the normalized structured data into the user's current profile prior to storing.

Another aspect of the invention provides additional security by encrypting the user's current profile using at least one encryption master key to generate a user's encrypted profile, and transmitting the user's encrypted profile to at least one cloud storage platform. This aspect of the invention is a privacy-preserving method for replicating personal health records to a third party server in order to make the record accessible on multiple devices or to other parties (such as caregivers & healthcare providers) at the patient's discretion. In one embodiment, the user may use standard encryption techniques to encrypt their personal record before transmitting the encrypted personal record data to a third party server or cloud storage system. In another embodiment, a password-based key generation algorithm such as a Password-Based Key Derivation Function (PBKDF) may be used to simplify key management. In another embodiment of this method, the patient may use an encryption key unique to their computing device or platform to encrypt their personal record.

Another aspect of the invention separates responsibilities over two separate implementations/parties; the UCCD with the responsibility to collect & redact unstructured personal data on behalf of an individual user, and an augmentation service with the responsibility to transform the de-identified unstructured data into a normalized form. It is thus verifiable through inspection of the transmitted data that PII remains exclusively on the UCCD and is not communicated to any 3^{rd} party. This separation of responsibilities enables some augmentation service embodiments to be implemented using a shared/multi-tenant environment without threatening the privacy of the user. The privacy implication of this scheme is that the relationship of the user to their de-identified and normalized data can only be established through the user's personal record maintaining copies of or references to such data.

### BRIEF DESCRIPTION OF THE DRAWINGS

FIG. 1 depicts an overview of the typical systems involved in the decentralized, or distributed aggregation process.

FIG. 2 depicts the novel methodology used to securely aggregate unstructured information on personally controlled computing devices.

FIG. 3 depicts the standard interface for personal account resources, typically an Internet website with a login or a mobile application using remote software/web services.

FIG. 4 depicts the augmentation process for normalizing and linking extracted data. The extracted data may be known to be free of sensitive PII information and thus anonymized in some embodiments, while other embodiments may still have, or are assumed to have, residual or unknown sensitive information therein. If the extracted data set is known to be anonymized, the augmentation process may occur on a centralized server for convenience considering the significant maintenance and storage requirements it entails. Otherwise, this process should be implemented on the local device to preserve the user's privacy.

FIG. 5 illustrates an example of a source-specific access logic script using Javascript (using JQuery-style element references). Other embodiments may use other languages and access strategies, such as direct network access using Network & HTTP calls. This is particularly necessary when the data source does not provide web interface and instead offers a TCP/IP based protocol.

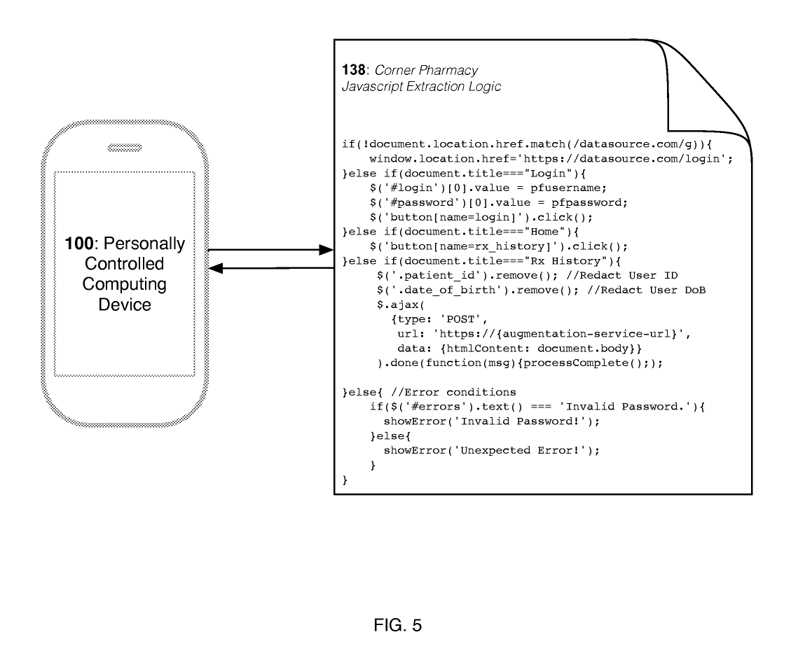

FIG. 6 illustrates the normalization of unstructured data via a multi-step process, including extraction, redaction, and transformation. This embodiment uses various processing techniques in combination to accomplish each step, but additional languages and technologies may also be used to achieve the same steps.

FIG. 7 provides a more detailed illustration of an example ID generation and linking processes from FIG. 4.

### DETAILED DESCRIPTION OF THE INVENTION

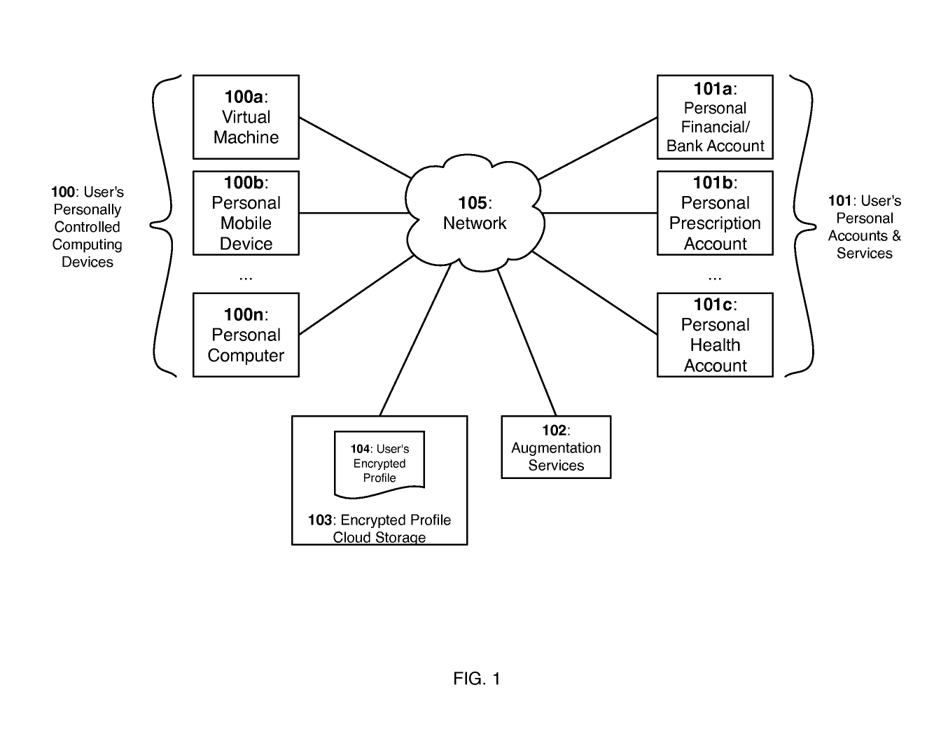

In FIG. 1, either on-demand or on a scheduled basis, any of a user's personally controlled computing devices 100 can remotely aggregate and redact the user's personal accounts 101 when connected to a common network 105. When the aggregation process completes, the raw output of the aggregation will be normalized & linked to other related entities using Augmentation Services 102. The resultant normalized records will then be returned to user's computing device 100 where it will be integrated with the user's other existing records. Once integrated, the user's device will encrypt the user's encrypted profile 104 with the user's encryption master key 131. The result will be stored on a generally accessible cloud storage platform 103 to ensure availability across devices or other users whom also possess decryption credentials.

Aggregation by the User-Controlled Computing Device

The user-controlled computing device (UCCD) for a given user is defined to be one or more general-purpose computing systems that is directly owned by or where the user exercises trust and full authority over its operation, such as with a leased or virtual computer. This contrasts with a centralized server device or system used by existing methods for aggregation wherein the user has limited trust and ability to influence its operation.

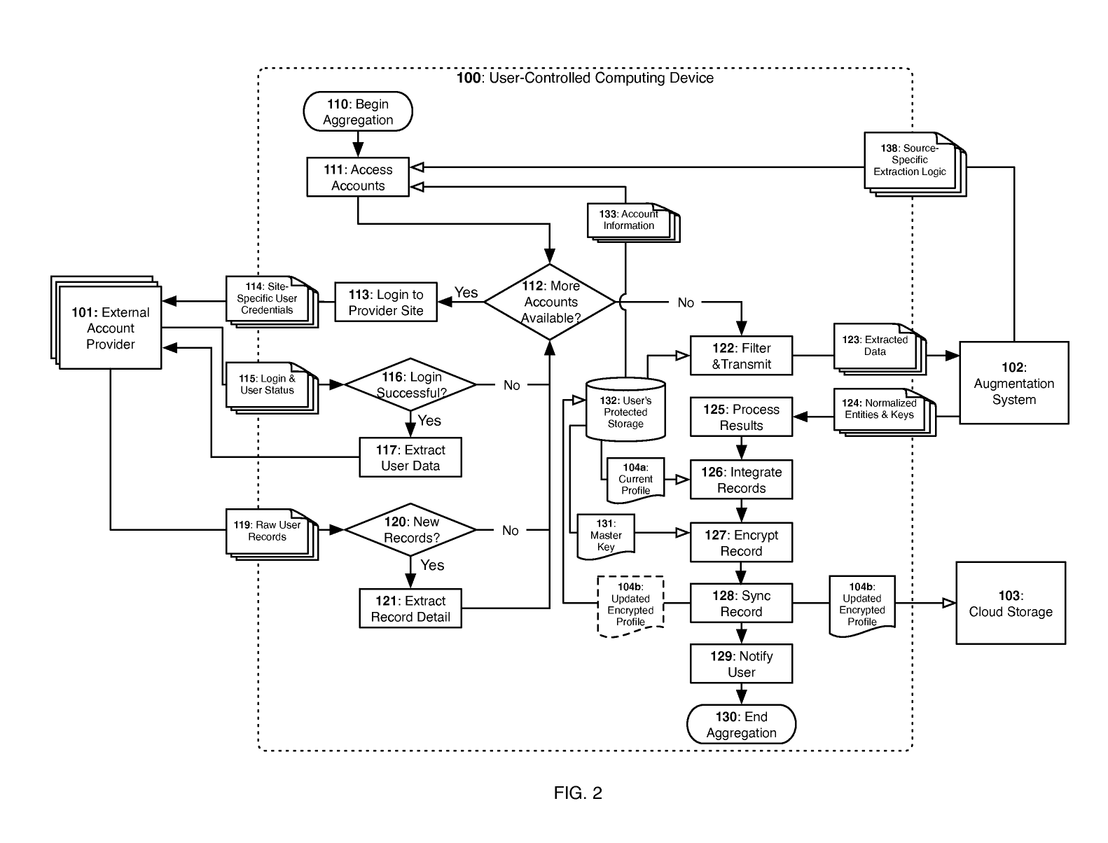

As shown in FIG. 2, when starting the aggregation process 110, the UCCD 100 system will begin accessing accounts 111 to review and access account information 133 retrieved from the user's protected storage 132. If there are unprocessed accounts still available 112, the system will proceed to login 113 to the external account 101 by using appropriate account credentials 114 and source extraction logic 138.

The login response 115 is examined for success/failure 116 as indicated in the user's encrypted profile 104. If the login fails, the account is skipped and process will begin checking for other available accounts 112. If, instead, a login is successful, the access script will then interrogate and extract user data 117 from the external account provider 101 using extraction logic 138 script. The UCCD system uses extraction logic, example illustrated in FIG. as extraction logic 138a, to interrogate the external account provider to generate and return raw data 119 in native form, normally highly unstructured and/or stylized for human consumption. Various embodiments of the extraction logic 138 exist, including static/compiled code embedded within the software and/or software library (e.g. C or Java) or dynamically downloadable runtime-interpreted instructions (e.g. Javascript or Groovy) depending on specific needs. This extraction script 138 provides both the logic for navigating and extracting the raw data 119 from the specific external account provider 101 system as well as identifiers for extractable sets.

The raw data 119 is optionally searched for relevant new identifiers, links, or other deviations from the previous aggregation that may be indicative of new information being available. If new data is detected 120 or if the raw data is too unstable to depend upon the presence of consistent identifiers, the entire account record is extracted 121 which may require additional requests back to the external account provider 101. If the UCCD system determines the account content has not changed, however, the system will finish processing that account prematurely and begin processing another account.

Once the information has been fully collected with no more available accounts 112, additional general-purpose redaction filter scripts 122 with specific knowledge of the user's sensitive identifiers may be applied to further reduce the possibility of unintended sensitive personal data from being included in the extracted data set 123. In the illustrated embodiment the name, SSN, date of birth, and other highly sensitive personal identifiers kept in the user's protected storage 132 are redacted by the regular expressions and string pattern matching, though other embodiments may also include omitting any data deemed to be sensitive or unnecessary for subsequent processing. The extracted data 123 is transmitted to the augmentation system 102 which may be co-located on the device for additional security, speed & efficiency. Other embodiments may have a centralized instance of the augmentation system due to the significant space and maintenance requirements of the entity databases. Once each entity (e.g. an individual prescription) has been extracted and normalized 124 by the augmentation system, the returned data are processed to ensure validity and completeness of the process results 125. The key of each entity is compared to the current set stored as part of the user's current personal current profile 104a. If any of the entities are new or have been updated, the system may automatically integrate entities 126 representing the new data into the appropriate location within the user's current profile 104a or optionally prompt the user for input.

The patient's device (UCCD) then uses industry-standard techniques (e.g. AES) to encrypt the updated encrypted profile 104b using a user-provided secret cryptographic master key 131 to generate an encrypt record 127, potentially generated from a “master password” via industry standard key-derivation techniques (e.g. PBKDF2). This ensures that the patient's information and all external references to the anonymized remote entities remain secret. This strategy verifiably protects the privacy and security of the user while not inhibiting further enrichment or secondary use of the anonymized data by the augmentation system owner. Before the encrypted user record 104b is synced 128, it is stored locally and optionally sent to the cloud service 103 to be available to other devices.

Alternate encryption schemes may also be used to enable access to the record for other trusted parties. Using asymmetric key encryption, for example, a user may also encrypt portions of their record with a plurality of public keys belonging to trusted 3^{rd} parties including family members, assistants, healthcare providers, or financial advisors. Other embodiments may employ a shared symmetric key scheme whereby a common key is shared by a plurality of trusted parties through standard key distribution techniques. Such schemes may also include the ability for the user to assign various delegated authorities to view or manipulate the record based using standard authorization control techniques.

The user may be notified 129 of relevant changes before the aggregation ends 130 and updates the appropriate event logs.

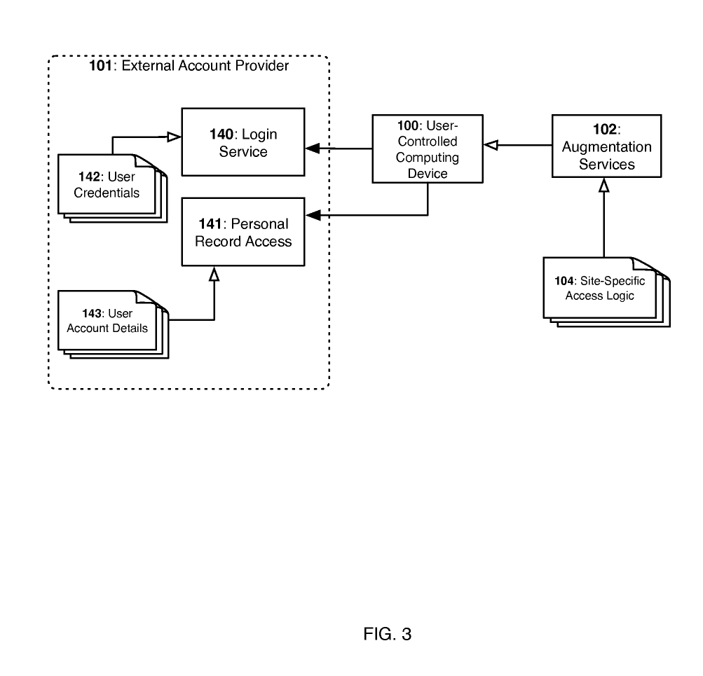

As shown in FIG. 3, the External Account Provider 101 may be any web-based source of personal data. Various examples of these services may be healthcare related patient portals or apps, financial dashboards, or any service operating as an external gateway to an individual's personal data. Such services typically offer many endpoints for accessing personal information though are normally controlled by a central login service 140. The provided credentials are verified with the stored user credentials 142 to determine validity. Once successfully authenticated, the service will normally provide a token of some sort (often UUID/cookie or digital signature) that enables access 141 to the user's personal account details 143.

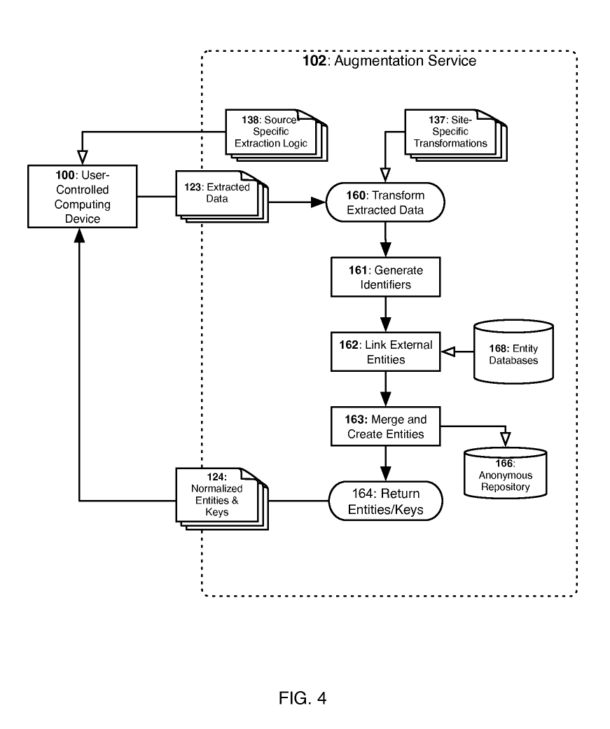

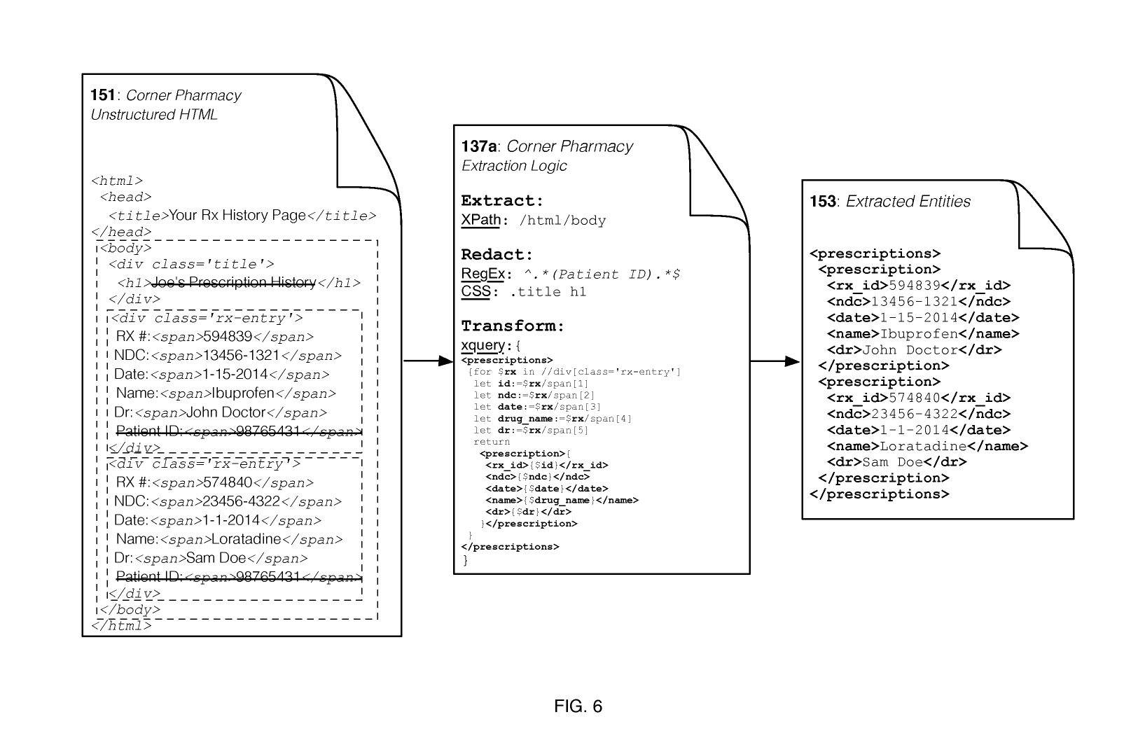

As shown in FIG. 4, the augmentation service 102 entities are normalized and linked from a user's raw extracted data 123 starting with the transformation process 160. The augmentation service will use site-specific logic 137, illustrated in FIG. 6 as extraction logic 137a that creates extracted entities 153 from unstructured HTML 151, to extract the relevant elements from the extracted data, further redact the data if sensitive information remains, and transform the unstructured data into a normalized form. As part of this normalization, a unique ID 161 is derived for each extracted entity using a plurality of data elements contained within the entity to avoid invalid collisions with other unique entities found in the entity databases 168 but still generate a common value when linked external entities 162 are merged 163, returned 164 and collected on subsequent aggregation or from an alternate source.

Extractable information may be identified in several ways, including but not limited to X-Path expressions, CSS selectors, or even regular expressions depending on the circumstance. Each extraction script is custom tailored for a specific external account provider. Each must extract only relevant personal details (identifiers, metrics, values) without including sensitive PII data or information not belonging to the user (e.g. copyrighted information belonging to the external account provider). This is achieved through judicious use of highly-specific extraction IDs and post processing to minimize any incidental data.

To further illustrate, while information about a given prescription may be available to an individual user through both an insurance and pharmacy account, it should never appear as two separate prescriptions. To avoid this problem it may seem sensible to simply use the pharmacy-assigned Rx Number as the prescription ID. Unfortunately, that approach would cause a collision with any other prescriptions issued by a different pharmacy but using the same Rx Number. Additional entropy is added by also including the ID of the pharmacy itself. This may still prove insufficient since some pharmacies will eventually recycle Rx Numbers over a period of several years, so we again add the original dispense date. Since we are reasonably certain that any single Rx Number assigned by a specific pharmacy on a given date refers to one (and only one) prescription, we can use that to generate a deterministic unique ID:

SHA256 (RxNumber+Pharmacy ID+Dispense Date)=Prescription ID

While this embodiment uses SHA256 for generating the unique prescription ID, other embodiments may use alternate deterministic methods of generating a unique prescription ID including other hash functions.

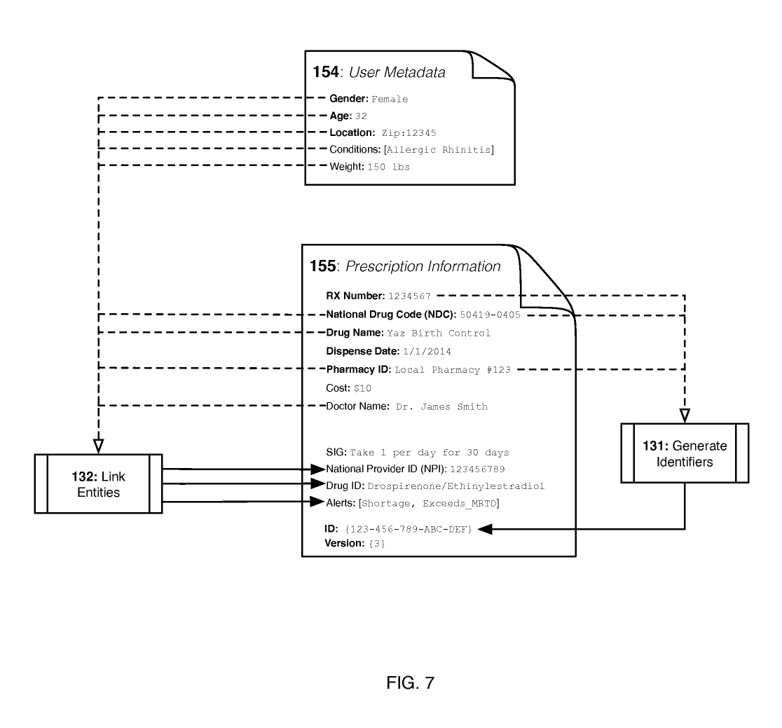

FIG. 7 illustrates an example ID generation and linking process from FIG. 4. This embodiment generates identifiers (ID) 131 from user metadata 154 and prescription information 155 through associated link entities 132. The process uses a minimal set of required elements from the normalized input to generate a specific identifier. Additional user metadata 154, however, is also considered in order to improve the accuracy of matching to external link entities 132. In the illustrated example, the user's metadata 154, gender, age, and regional-level location are considered along with the medication's prescription information 155, NDC, drug, and dispensing pharmacy when trying to determine the specific identity of the prescribing doctor (National Provider Identifier or NPI) since the name of the doctor alone is normally insufficient for unique identification. In the illustrated example, the system may consider the user's metadata 154 to filter possible doctor matches based on the doctor's location & specialization. The system may also consider user metadata 154 to resolve a fuzzy identifier, such as a drug name, without a clear deterministic match to a known entity-narrowing possible matches based on the user's identified conditions, weight, or gender until a single match remains.

Continuing in FIG. 4, the augmentation service 102 may then link external entities 152 from other entity databases 158 using the newly transformed entity information. For example, a healthcare-specific embodiment may use the NDC of the prescription to link to the FDA drug information database. Other financially focused embodiments may use a provided routing number to identify and link appropriate banking information.

While there has been shown and described what are at present considered the preferred embodiments of the invention, it will be obvious to those skilled in the art that various changes and modifications can be made therein without departing from the scope.

1. A computer-implemented privacy-preserving method for aggregating unstructured personal data comprising the steps of:
accessing at least one external account to form extracted personal data using a user-controlled computing device (UCCD),
redacting relevant portions of said extracted personal data representing personal identifiable information (PII) using said UCCD, thereby forming de-identified personal data,
transforming said de-identified personal data into normalized structured data, wherein said transforming is performed by at least one device selected from the group consisting of said UCCD and a centralized augmentation system, and
storing said normalized structured data in the user's current profile on said UCCD.

2. The method of claim 1 wherein said transforming comprises:
transmitting said de-identified personal data to at least one of said centralized augmentation system wherein said at least one centralized augmentation system is remote,
receiving said normalized structured data from said at least one augmentation system into said user's current profile, and
integrating said normalized structured data into said user's current profile.

3. The method of claim 1 further comprising the steps of:
encrypting said user's current profile using at least one encryption master key to generate a user's encrypted profile, and
transmitting said user's encrypted profile to at least one cloud storage platform.

4. The method of claim 1 wherein said personal data is accessed from at least one source selected from the group consisting of medical information, financial information, legal information, educational information, social information, healthcare related patient portals or apps, financial dashboards, and external gateways to personal data.

5. The method of claim 1 wherein said method steps are performed on-demand.

6. The method of claim 1 wherein said method steps are performed on a scheduled basis.

7. The method of claim 1 wherein said redacting further comprises using updatable extraction logic to interrogate the external account and extract unstructured personal data in native form.

8. The method of claim 1 wherein said redacting further comprises searching for deviations from previous aggregations indicative of new information.

9. The method of claim 1 wherein said transforming further comprises generation of a unique ID for each extracted entity derived from a plurality of related data elements.

10. A computer-implemented system for securely aggregating unstructured personal data comprising:
at least one user controlled computing device (UCCD) configured to access unstructured personal data from at least one external account to form extracted personal data, redact personal identifiable information (PII) from said extracted personal data into de-identified personal data, transform said de-identified personal data into normalized personal data, and store said normalized personal data in a user's current profile.

11. The system of claim 10 wherein said at least one UCCD is further configured to:
transmit said de-identified personal data to at least one centralized augmentation system, said centralized augmentation system configured to transform said de-identified personal data into normalized structured data,
receive said normalized structured data from said at least one augmentation system into said user's current profile prior to storing, and
integrate said normalized structured data into said user's current profile prior to storing.

12. The system of claim 10 wherein said UCCD is further configured to:
encrypt said user's personal record using at least one encryption key, and
transmit said user's encrypted personal record to a cloud storage platform, enabling access across said UCCDs by other trusted parties.

13. The system of claim 10 wherein said at least one UCCD is configured to access unstructured personal data from at least one source selected from the group consisting of medical information, financial information, legal information, educational information, social information, healthcare related patient portals or apps, financial dashboards, and external gateways to personal data.

14. The system of claim 10 wherein said system is initiated on-demand.

15. The system of claim 10 wherein said system is initiated on a scheduled basis.

16. The system of claim 10 wherein said extracted personal data further comprises extraction logic to interrogate said at least one external account and generate raw personal data in native form.

17. The system of claim 10 wherein said extracted personal data further comprises PII-specific filter scripts for generating said extracted personal data.

18. The system of claim 10 wherein said normalized personal data further comprises a means for generating a unique ID for each extracted entity derived from a plurality of related data elements.

19. A computer-implemented system for securely aggregating unstructured medical personal data comprising:
at least one user controlled computing device (UCCD) configured to access unstructured medical personal data from at least one external account to form extracted medical personal data, redact personal identifiable information (PII) from said extracted medical personal data into de-identified medical personal data, transform said de-identified medical personal data into normalized medical personal data, and store said normalized medical personal data in a user's current profile.

20. The system of claim 19 wherein said at least one UCCD is further configured to:
transmit said de-identified medical personal data to at least one centralized augmentation system, said centralized augmentation system configured to transform said de-identified medical personal data into normalized medical structured data,
receive said normalized medical structured data from said at least one augmentation system into said user's current profile prior to storing, and
integrate said normalized medical structured data into said user's current profile prior to storing.

21. The system of claim 19 wherein said UCCD is further configured to:
encrypt said user's medical personal record using at least one encryption key, and
transmit said user's encrypted medical personal record to a cloud storage platform, enabling access across said UCCDs by other trusted parties.

22. The system of claim 19 wherein said system is initiated on-demand.

23. The system of claim 19 wherein said system is initiated on a scheduled basis.

24. The system of claim 19 wherein said extracted medical personal data further comprises extraction logic to interrogate said at least one external account and generate raw medical personal data in native form.

25. The system of claim 19 wherein said extracted medical personal data further comprises PII-specific filter scripts for generating said extracted medical personal data.

26. The system of claim 19 wherein said normalized medical personal data further comprises a means for generating a unique ID for each extracted entity derived from a plurality of related data elements.

27. A computer-implemented privacy-preserving method for aggregating unstructured personal data comprising the steps of:
receiving de-identified personal data from at least one UCCD into at least one centralized augmentation system,
transforming said de-identified personal data into normalized structured data,
transmitting said normalized structured data from said at least one augmentation system to a user's current profile on said at least one UCCD.
